(19) United States
(12) Patent Application Publication
(10) Pub. No.: US 2012/0309474 A1
(43) Pub. Date: Dec. 6, 2012

(54) Cellular Phone Cover

(76) Inventors: Anthony Walker, Ocean, NJ (US); Brian Nelson, Ocean, NJ (US)

(21) Appl. No.: 13/153,894

(22) Filed: Jun. 6, 2011

(51) Int. Cl. H04M 1/00

(52) U.S. Cl. 455/575.8

(57) ABSTRACT

A cover for protecting a cellular phone comprising: a top edge; a bottom edge; side edges, where the side edges connect the top edge and bottom edge; an outer surface; and a plurality of tentacles, where said tentacles extend from the outer surface. During use the top edge, bottom edge and side edges extend over the outer edges of the cellular phone to provide suitable protection for the cellular phone.

### BACKGROUND OF THE INVENTION

1. Field of Invention

The present invention relates to a cell phone cover that is utilized to cover and protect a cellular phone.

2. Description of Related Art

Cellular phones are widely used by many individuals and are supplied in various forms and shapes. Cellular phone usage is prevalent throughout the world and many cell phone users continue to seek and use the various cell phone technologies as more cellular phones are released on the market. The cellular phone has evolved from larger phones that require special holsters to transport to the popular flip phone that was used for a number of years and more recently the rectangular Smartphone which includes various features in addition to voice communications. As cell phones have evolved so have the holders, protectors and carry cases that have been developed to house and store these cell phones during transport.

Many of the cellphone holders or cases are used to protect the cell phone in case it is accidently dropped by the user. The cell phone is generally manufactured out from hard plastic materials and may also include a screen of some sort provide a communication means for the user. The more recent cell phones such as the Smartphone include a substantially rectangular design that includes a screen that may be a touch screen to handle the various functions that are related to the Smartphone. The covers have been developed for these phones surround the outer edges of the phone and help to protect the phone from damage if accidently dropped during use. Typically, the covers are made of various materials such as plastic, rubber, leather or polyester materials. Because of the significant use of cell phones the need for various covers and sleeves is almost endless.

### SUMMARY OF THE INVENTION

The present invention relates to a cover for protecting a cellular phone comprising: a top edge; a bottom edge; side edges, where the side edges connect the top edge and bottom edge; an outer surface; and a plurality of tentacles, where said tentacles extend from the outer surface. During use the top edge, bottom edge and side edges extend over the outer edges of the cellular phone to provide suitable protection for the cellular phone.

### BRIEF DESCRIPTIONS OF DRAWINGS

FIG. 1 depicts a cell phone cover in accordance with the present invention.

### DETAILED DESCRIPTION

The present invention relates to a cellular phone cover that is particularly designed for a smartphone design that is widely used by many consumers. The cellular phone cover according to present invention includes a four-sided cover that slides around the back panel of a cellular phone and provides a protective covering for the phone while being used. The cellular phone cover according to present invention also includes a plurality of tentacles that extend over the outer surface of the cell phone cover. The tentacles are crafted of a rubber gel-type material and provide a durable cover for a cellular phone. The cover may also be made of a gel-type or rubber material and tentacles may also include a light source therein to indicate the receipt of a phone call.

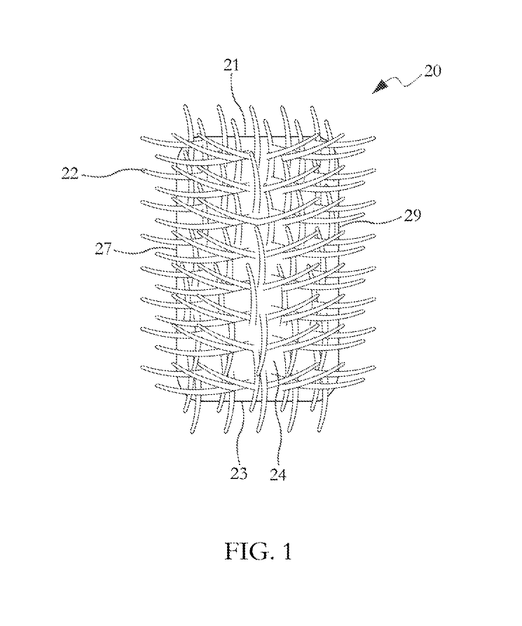

In reference to FIG. 1, a Cellular Phone Cover 20 according to the present invention is depicted. The Cellular Phone Cover 20 includes a Top Edge 21 and a Bottom Edge 23. Side Edge 27 and Side Edge 29 join the Top Edge 21 and Bottom Edge 23 of the Cell Phone Cover 20. The Cell Phone Cover 20 is designed to easily slide over the back panel of a rectangular Smartphone that is currently on the market. Examples of rectangular Smartphones include the iPhone, Blackberry, Android, and other similar rectangular-shaped cell phones. Although depicted with this particular shape the Cell Phone Cover 20 according to the present invention may also be embodied in a square shape or other shapes that may be conducive to the ever-changing Smartphone technology.

In addition to providing a cover, the Cell Phone Cover 20 further includes a plurality of Tentacles 22 that extends over the Surface 24 of the Cell Phone Cover 20. The Tentacles 22 extend in various directions across the Outer Surface 24 of the Cell Phone Cover 20. The Tentacles 22 may be made of a rubber gel-type material to provide protection and durability in order to protect the respective cell phone. The Tentacles 22 may also include a light source mechanism to indicate that the user is receiving an incoming call on the cell phone.

The Cell Phone Cover 20 provides a lightweight accessory that encloses the side and rear portions of a cellular phone for protection. Each respective edge, Top Edge 20, Bottom Edge 23 and Side Edges 27, 29 extend over the sides and edges of a cellular phone. The Tentacle Extensions 22 provides texture and an additional means of protection for the cellphone. Further light sources may be embedded within the tentacles so that a light emits upon the vibration or ringing of the cellular phone. The instant invention has been shown and described in what it considers to be the most practical and preferred embodiments. It is recognized, however, that departures may be made there from within the scope of the invention and that obvious modifications will occur to a person skilled in the art.

What is claimed is:

1. A cover for protecting a cellular phone comprising:
a. a top edge;
b. a bottom edge;
c. side edges, where the side edges connect the top edge and bottom edge;
d. an outer surface; and
e. a plurality of tentacles, where said tentacles extend from the outer surface.

2. The cover according to claim 1, where the top edge, bottom edge and side edges extend over the outer edges of the cellular phone.

3. The cover according to claim 1, where said tentacles include a light source.

4. The cover according to claim 3, where said light source provides a means to indicate an incoming call to the cellular phone.

5. The cover according to claim 1, where said cover is made of a rubber material.
